(19) United States
(12) Patent Application Publication
(10) Pub. No.: US 2025/0249488 A1
(43) Pub. Date: Aug. 7, 2025

(54) ENVIRONMENTALLY FRIENDLY INTERLEAVING MATERIAL

(71) Applicant: Teknapack, Inc., Lino Lakes, MN (US)

(72) Inventor: Fredrik Johnson, Lino Lakes, MN (US)

(21) Appl. No.: 18/734,257

(22) Filed: Jun. 5, 2024

Related U.S. Application Data
(60) Provisional application No. 63/627,899, filed on Feb. 1, 2024.

(51) Int. Cl. B08B 3/14

(52) U.S. Cl. CPC B08B 3/14

(57) ABSTRACT

Embodiments of the present disclosure describe interleaving materials and related methods. A method of removing an interleaving material from glass to reduce environmental pollution includes washing the glass with a liquid to remove an interleaving material from the glass, wherein the interleaving material includes regenerated cellulose and is marine biodegradable. An interleaving material includes regenerated cellulose, wherein the interleaving material is marine biodegradable and has a specific gravity of at least 1.03.

### CROSS-REFERENCE TO RELATED APPLICATION

This application claims benefit of U.S. Provisional Application No. 63/627,899, filed on Feb. 1, 2024. U.S. Provisional Application No. 63/627,899 is incorporated herein by reference. A claim of priority is made.

### BACKGROUND

It is known in the art that glass articles are susceptible to marring and corrosion while being, for example, transported and stored. Such damage can be caused by contact with neighboring glass articles and other objects, as well as chemical reactions in which the chemical bonds forming the glass are broken or destroyed, thereby dissolving the glass and staining the surfaces thereof. Damage to the glass is a prevalent concern in stacked glass sheets in which a plurality of glass sheets are arranged or packed in a general face-to-face orientation. The stacked orientation of the glass sheets can increase the frequency of contact between adjacent sheets, causing marring. Marring can be particularly pronounced in stacks comprising glass sheets with pyrolytic deposited metal oxide and silicon-containing coatings thereon. In addition, the environmental conditions under which stacked glass sheets are transported and/or stored, which are difficult to control, can lead to corrosion.

Interleaving materials are typically placed between glass sheets and are used to prevent glass destruction and marring. These materials are placed between glass articles prior to transportation or storage. Typically, a washing process is used to remove the interleaving material from the glass after transportation and/or storage. Since most interleaving materials that are washed from the glass include non-biodegradable polymeric microplastics, these interleaving materials cause environmental pollution by entering wastewater treatment facilities and the aquatic ecosystem.

### SUMMARY OF THE INVENTION

Improved interleaving materials for separating and protecting glass sheets during transportation, storage, and the like are disclosed herein.

According to one aspect, a method of removing an interleaving material from glass to reduce enduring environmental pollution includes washing glass with a liquid to remove an interleaving material from the glass, wherein the interleaving material includes regenerated cellulose and is marine biodegradable.

According to another aspect, an interleaving material includes regenerated cellulose, wherein the interleaving material is marine biodegradable and has a specific gravity of at least 1.03.

According to another aspect, an interleaving material includes regenerated cellulose and disodium citrate, wherein the interleaving material has a specific gravity of at least 1.03.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 for removing an interleaving material from glass to reduce enduring environmental pollution, according to some embodiments.

### DETAILED DESCRIPTION

### Definitions

As used herein, the term “stacked glass sheets” refers to a plurality of glass sheets, which can be coated or uncoated, stacked adjacent to one another with a face-to-face orientation. The stacking can be characterized as a vertical stacking, horizontal stacking, or inclined stacking.

As used herein, the terms “enrobed,” “enrobe,” “enrobing,” and the like refer to covering at least a portion of a surface of an interleaving material with a material. For example, an enrobed material can refer to a particle or bead having an organic acid coating deposited on at least a portion of the particle or bead. In another example, the term enrobing can refer to processes in which at least a portion of a particle or bead is coated with an organic acid. Materials can be enrobed by any of a variety of techniques. Suitable techniques for enrobing include, but are not limited to, spray drying, atomization, deposition, and the like. The term enrobing includes encapsulating, coating, depositing, covering, sorbing (e.g., absorbing, adsorbing, desorbing, etc.), and the like.

As used herein, the terms “impinged,” “impinge,” “impinging,” and the like refer to covering at least a portion of an interior surface of an interleaving material with a material. For example, an impinged material can refer to a porous particle or bead in which an organic acid is present in at least a portion of the pores of said particle or bead. In another example, the term impinging can refer to a process and/or material in which a porous particle or bead is impregnated, infused, and/or saturated with an organic acid. In a further example, an impinged material can refer to a porous particle or bead in which an organic acid component is at least partially pressed into a surface of said particle or bead (e.g., may be immobilized, associated, and/or connected therewith). Materials can be impinged by any of a variety of techniques. Suitable techniques for impinging include, but are not limited to, spray drying, atomization, deposition, immersion, wetness incipient impregnation, and the like. The term “impinging” includes penetrating, injecting, diffusing, sorbing (e.g., absorbing, adsorbing, desorbing, etc.), incorporating, and the like.

As used herein, the term “alkali” refers to metals including one or more of lithium, sodium, potassium, rubidium, caesium, and francium. The alkali metals can be present in ionic or elemental form.

As used herein, the term “alkaline earth metal” refers to metals including one or more of calcium, magnesium, beryllium, strontium, barium, and radium. The metals can be present in ionic or elemental form.

As used herein, the term “neutralize” or “neutralizing” or “neutralization” and the like can refer to chemical reactions between an alkaline species with an acidic species, which is preferably the organic acids disclosed herein.

As used herein, the term “marine biodegradable” refers to a material capable of biodegrading under marine environmental conditions including aerobic marine waters and/or anaerobic marine sediment. In one example, material may be capable of completely biodegrading without leaving toxic substances or residue. In another example, the marine biodegradable material is at least partially degradable under marine environmental conditions.

Embodiments of the present disclosure provide improved interleaving materials for separating and protecting glass sheets during transportation, storage, and the like. The interleaving materials can be utilized for preventing or retarding the formation of stains on the surfaces of glass sheets and physically or mechanically separating adjacent glass sheets during transit or storage, among other situations. These interleaving materials can adhere or lightly bind to the surfaces of both coated and uncoated glass sheets, thereby minimizing waste and reducing over application. During transportation or storage of stacked glass sheets, the interleaving materials can provide superior protection and resistance to marring and scratches, while also inhibiting or preventing staining of the glass surfaces. The interleaving materials can also be utilized to separate glass sheets without creating a vacuum seal that prevents the disassembly and separation of stacked glass sheets. Importantly, interleaving materials of the present disclosure reduce environmental pollution and can be used with existing water washing systems. In one example, pollution includes the addition of microplastics, toxic chemicals, and/or non-biodegradable solids into the environment. In another example, pollution includes particulate suspended solids in water.

Conventionally, interleaving material typically includes microplastics such as poly(methyl methacrylate) (PMMA). These microplastics are typically removed by a water washing process. Unfortunately, since water is used to remove the microplastics from the glass, these microplastics require additional filtration media and can enter the wastewater discharge stream causing environmental microplastic pollution. To combat microplastic pollution, nut flour, coconut flour, and wood dust have been tested as interleaving materials. These materials tend to break into smaller dust generating particles and physically deteriorate under mechanical stress. The interleaving materials disclosed herein overcome the challenges and shortcomings of conventional materials.

Embodiments of the present disclosure include environmentally friendly and non-toxic interleaving materials. Interleaving materials of the present disclosure generally include regenerated cellulose. These interleaving materials exhibit superior flexibility and structural stability when in contact with glass materials. Further, these interleaving materials are marine biodegradable and, if the interleaving materials enter a wastewater discharge process, these materials minimize the turbidity of fresh water, which can be detrimental to freshwater quality. Accordingly, these materials reduce the enduring environmental pollution by minimizing the duration of negative impact on the environment.

The regenerated cellulose may include materials manufactured by chemically converting natural cellulose to a soluble cellulosic derivative and subsequent regeneration. The regeneration process may include dissolving material, purifying material, and/or extruding material. For example, regenerated cellulose may be manufactured by dissolving wood pulp in amine oxide solution. In one example, the regenerated cellulose includes one or more of Rayon, Lyocell, viscose, and microcrystalline cellulose (MCC). These regenerated cellulose materials exhibit an extensive polymer entanglement which minimizes physical deterioration due to mechanical stress. In another example, the interleaving material includes cellulose fiber derivatives including cellulose esters (e.g., nitrocellulose, cellulose acetate, cellulose triacetate, cellulose propionate, cellulose acetate propionate, cellulose acetate butyrate, and cellulose sulfate) and cellulose ethers (e.g., methylcellulose, ethylcellulose, ethyl methyl cellulose, hydroxyethyl cellulose, hydroxyethyl methyl cellulose, hydroxypropyl methyl cellulose, ethyl hydroxyethyl cellulose, and carboxymethyl cellulose); and the like. In yet another example, the interleaving material includes a marine biodegradable composite material produced using drying oils such as linseed or tung oil.

In some embodiments, the interleaving material includes interleaving particles and/or beads. The regenerated cellulose may be enrobed and/or impinged with one or more organic acids, or salts thereof. The enrobing or impinging of the interleaving particles or beads with the organic acids or salts thereof can be achieved through chemical or physical adherence or bonding, or any combination thereof. In one example, the regenerated cellulose is enrobed and/or impinged with one or more carboxylic acids. In another example, the regenerated cellulose is enrobed and/or impinged with one or more of adipic acid, boric acid, sodium borate, citric acid, buffered citric acid, succinic acid, and tartaric acid. In one example, in interleaving applications, the energy efficiency of a boric acid aqueous solution favors formation of sodium borate which prevents the formation of sodium hydroxide. In yet another example, the interleaving material includes disodium citrate. The disodium citrate can be in contact with the regenerated cellulose.

In some embodiments, suitable organic acids can include acids containing at most 20 carbon atoms, including aliphatic acids and aromatic acids, either or both of which can be substituted or unsubstituted. Examples of suitable substituents include, but are not limited to, hydroxy (—OH), carboxylic (—COOH), sulfo (—SO₃H), phosphates (—PO₄H₂), sulfhydryl (—SH), and amino (—NH₂), among others. In some embodiments, the organic acids include carboxylic acids. For example, the organic acids can include monocarboxylic acids, dicarboxylic acids, tricarboxylic acids, and tetracarboxylic acids. In some embodiments, the organic acids comprise hydroxy acids, or acids comprising hydroxyl groups and carboxyl groups.

For example, the organic acids can include hydroxy carboxylic acids, such as hydroxy monocarboxylic acids, hydroxy dicarboxylic acids, hydroxy tricarboxylic acids, hydroxy tetracarboxylic acids, and so on. Non-limiting examples of suitable organic acids include gluconic acid, stearic acid, palmitic acid, citric acid, tartaric acid, malic acid, DL-tropic acid, glyceric acid, aldonic acids, maleic acid, sebacic acid, succinic acid, saccharic acid, mannaric acid, salicylic acid, adipic acid, stearic acid, itaconic acid, lactic acid, sodium acetate, boronic acid, fumaric acid, benzoic acid, oganotin compounds such as oganotin halides, alkyltin halides such as methyltin trichloride and dimethyltin dichloride, sodium bisulfate, and the like. Examples of salts of organic acids include sodium salts, potassium salts, ammonium salts, calcium salts, magnesium salts, and the like. In some embodiments, for example, the organic acid includes sodium salts, such as sodium salts of gluconic acid and/or citric acid and/or sodium gluconate and/or sodium citrate (e.g., disodium citrate). These organic acids shall not be limiting as other salts can be utilized herein without departing from the scope of the present disclosure.

The organic acid and salts thereof can be selected to neutralize alkaline species formed on or near the glass surface. For example, in some embodiments, a slow reaction can occur in which water reacts with alkali ions to form hydroxides. The presence of hydroxides increases the surface pH. Once the pH levels include to a pH of about 9 or greater, staining of the glass surface can result from severing of, for example, silicon-oxygen bonds. However, in the presence of an acid, the hydroxides can be neutralized, reducing staining of the glass or preventing it all together. Ions can leach out of glass and cause staining, and non-limiting examples of such ions include sodium, potassium, iron, manganese, boron, aluminum, and copper, among others, including ions from compounds incorporated into stained glass to provide color. In some embodiments, the ions include alkali ions, alkaline earth ions, or a combination thereof. All ions are intended to be within the scope of the present disclosure.

The organic acid can be selected from organic acids or salts thereof capable of neutralizing alkaline species, such as hydroxides. These organic acids may be used as stain-inhibiting organic acids. The organic acids may be provided in solid form, liquid form, gaseous form, or a combination thereof. In some embodiments, for example, the organic acids are provided in solid form, such as in the form of a powder, among other solid forms. In some embodiments, the solid form includes powder form, wherein the powder form is free flowing powder and/or maintains its form in the presence of moisture/ambient conditions/etc. In some embodiments, the organic acids include spray dried organic acids.

As discussed, in some embodiments, the interleaving material includes disodium citrate. In one example, disodium citrate can be combined with regenerated cellulose as a multi-component blend of powder materials utilizing various dry powder mixing techniques. In another example, disodium citrate can be combined with regenerated cellulose using a variety of solution combination and drying techniques. For example, disodium citrate may be combined with regenerated cellulose using spray drying. In another example, disodium citrate can be combined with regenerated cellulose using fluid bed granulation and drying. Fluid bed granulation and drying can produce a monolithic interleaving powder. Organic and/or inorganic water soluble buffer compounds can similarly be combined with regenerated cellulose using these methods. The disodium citrate can act as a corrosion inhibitor and pH buffer by maintaining the pH value near about 7.0 (for example from about 6.5 pH to about 7.5 pH). In one example, sodium may preferentially bond to disodium citrate rather than forming sodium hydroxide. Accordingly, the interleaving material can act as a buffer to inhibit the formation of sodium hydroxide. Additionally, since the disodium citrate is capable of stabilizing/maintaining a near-neutral pH value (such as during/after water washing), it is permissible to release the interleaving material to a downstream wastewater treatment plant. Compared to many washing processes that require a post-washing acid or base addition step to adjust the discharge pH value (to a pH value near about 7 pH), the interleaving materials of the present disclosure with disodium citrate can be used without dilution or buffering steps prior to wastewater discharge. This minimizes the environmental impact of the washing effluent in interleaving applications, and reducing added acids or bases also decreases cost.

In some embodiments, the regenerated cellulose is impinged to form a monolithic separating media (such as a monolithic interleaving powder) which improves powder applicator performance and reduces required maintenance of the powder applicators. Monolithic interleaving material also provides improved performance in that a single particle can provide both physical separation and chemical corrosion inhibition. Further, monolithic interleaving material can exhibit a uniform static electric charge profile, leading to a greater capacity to control the static electric attraction between the interleaving material and the targeted substance.

The interleaving material may include a coating, such as a surface coating. In some embodiments, the coating is utilized to promote adhesion (e.g., enrobing, impinging, etc.) of the organic acids and/or salts of organic acids. In some embodiments, the coating is utilized as a static eliminator. For example, in some embodiments, the coating is utilized to promote improved screenability (e.g., based on particle size). In some embodiments, the coating permits use of materials other than diatomaceous earth. In some embodiments, the coating removes the need for spray drying or any other sort of water management steps.

The interleaving materials of the present disclosure generally have a specific gravity of at least about 1.03. In one example, the interleaving material has a specific gravity of at least about 1.05. For example, the interleaving material may have a specific gravity of at least about 1.06, about 1.07, about 1.08, or about 1.09. In another example, the interleaving material has a specific gravity of at least 1.1. Importantly, since the interleaving material generally has a specific gravity of at least 1.03, the interleaving material is capable of sinking in water. Unlike nut flour, coconut flour, natural cellulose, and wood dust that all have a specific gravity of less than 1.0, making these materials difficult to capture, interleaving materials of the present disclosure may be utilized with existing glass washing systems since these systems are optimized to remove microparticles that sink in water.

The forms in which the interleaving particles are provided can include, but are not limited to, various solid forms, such as interleaving microparticle powders, as well as larger forms, such as beads. These particles or beads can be chemically inert materials. In some embodiments, beads include substantially spherical beads. Accordingly, the particle size or average particle size of the interleaving material containing particles or beads is not particularly limited and can be in the range of about 0.01 micron to about 3 cm, or any range or value thereof. In one example, the average particle size of the interleaving material ranges from about 1 μm to about 1000 μm. The interleaving material can be utilized as a support for the organic acids. Further, the interleaving particles or beads are mechanically strong, sufficient to withstand the pressures and other forces that are present between glass articles, such as stacked glass sheets, of any size, to provide the requisite physical separation between adjacent glass surfaces.

To prepare interleaving materials comprising interleaving particles or beads enrobed or impinged with organic acids or salts thereof, methods such as spray drying, milling, extruding, or coating processes, or combinations thereof, can be utilized. In some embodiments, spray drying is utilized for thermally sensitive polymers to prevent, for example, decomposition or degradation thereof. Any spray drying process or apparatus known in the art can be utilized herein to prepare interleaving materials. For example, a solution or slurry of an organic acid can be fed to a spray dryer apparatus where said solution or slurry is atomized and administered through a spray nozzle configured to disperse the solution over the interleaving particles or beads. Advantageously, spray dryers afford a high degree of control over the droplet size of the liquid or slurry being dispersed. Following the dispersing, the interleaving particles or beads can be enrobed or impinged with the organic acid, which are then subjected to a hot gas to flash off solvent and obtain enrobed and/or impinged interleaving material.

Other processes can combine extrusion processes with milling processes to produce the interleaving materials. For example, in some embodiments, a solution or slurry comprising an organic acid can be prepared and combined with the interleaving particles or beads. The resulting mixture can be extruded or coated onto a belt using, for example, rollers, bar-coaters, slot-die-coaters, blade-coaters, knife-coaters, roll-coaters, wire-bar coaters, dip-coaters, and spray-coaters, etc. The extruding or coating can then be subjected to drying. Non-limiting examples of drying include heating, evaporating, irradiating with ultraviolet radiation, among other techniques known in the art, to form a film. The film can further be subjected to fracturing processes, such as milling to obtain enrobed and/or impinged interleaving material. Non-limiting examples of milling include hammer milling, pin milling, and ball milling (e.g., dry ball milling), among other techniques.

Embodiments further include applications of interleaving materials. The applications can include methods of applying interleaving materials comprising disposing a plurality of interleaving materials onto a surface of a glass article. The disposing can include contacting the plurality of interleaving materials with a surface of a glass article. Preferably, the disposing is conducted such that substantially all the interleaving materials are contacted with a glass surface to minimize losses and waste. The glass article is any article comprising glass and thus is not particularly limited. An example of an exemplary glass article is glass sheets, preferably stacked glass sheets. The glass article can be uncoated or coated (e.g., coated with a low-emissivity or low-E coating, among others). Advantageously, the interleaving particles disclosed herein can be applied and adhere to both coated and uncoated glass articles.

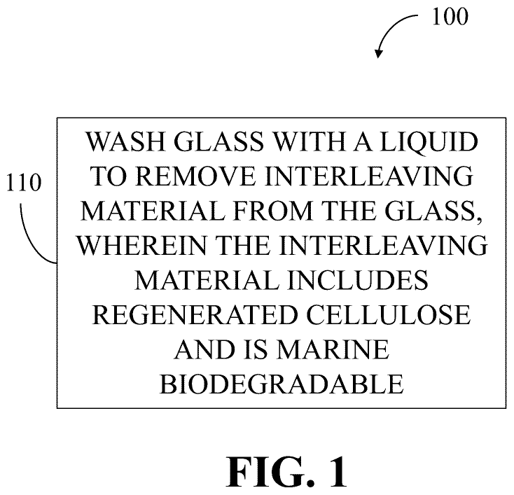

Referring to FIG. 1, method 100 for removing an interleaving material from glass to reduce enduring environmental pollution is provided. Method 100 includes the following step:

STEP 110, WASH GLASS WITH A LIQUID TO REMOVE INTERLEAVING MATERIAL FROM THE GLASS, WHEREIN THE INTERLEAVING MATERIAL INCLUDES REGENERATED CELLULOSE AND IS MARINE BIODEGRADABLE, includes washing glass, such as stacked glass, with a liquid, such as water, to remove the interleaving material from the glass. Washing generally includes contacting liquid with one or more of the interleaving material and the glass, and removing the interleaving material from the glass may include removing/separating at least a portion of the interleaving material from the surface of the glass. The glass may include a plurality of glass sheets arranged into stacks. Step 110 may include providing and using a water-washing process to remove the interleaving material from the glass. The interleaving material of method 100 includes interleaving materials of the present disclosure, and these interleaving materials may be adhered to and/or in contact with the glass prior to the washing process.

As discussed, due to the unique interleaving materials of the present disclosure, the washing effluent may not require buffering or dilution prior to discharge. Method 100 may further include capturing interleaving material prior to transferring the water to a downstream wastewater discharge process. This water may have a pH value ranging from about 6.5 pH to about 7.5 pH after washing. Capturing the interleaving material may include contacting water and/or the interleaving material with a filter. This filter may be upstream of a downstream wastewater discharge process. In one example, more than 50%, more than 75%, or more than 90% of interleaving material initially adhered to the glass may be removed prior to discharging the water to a downstream wastewater discharge process. In one example, more than 95%, or more than 98% of interleaving material initially adhered to the glass can be removed prior to discharging water to a downstream wastewater discharge process. In another example, since the interleaving material may have a specific gravity of at least 1.03, any interleaving material that is released to downstream systems and the environment has a minimal impact on freshwater turbidity. For example, many washing systems require a wide range of care regarding maintenance, and washing systems have a wide range of solid capture capability. Therefore, interleaving materials of the present disclosure minimize environmental impact if the washing system is poorly capable of capturing solids or if the system is poorly maintained. Suspended solids in freshwater cause harm to aquatic ecosystems. Therefore, it is important to use an interleaving material that can sink in water and minimize turbidity.

Typical glass washing systems are designed to separate and remove non-biodegradable polymeric microplastics that sink in water. These typical glass washing systems rely on heavy plastic microparticle sinking and removal of a portion of these microparticles prior to discharging water to downstream processes. Since the interleaving material of the present disclosure may have a specific gravity of at least 1.03, the interleaving material can be utilized with existing water washing systems. Importantly, the interleaving materials of the present disclosure also solve the current pollution problem caused by non-biodegradable polymeric microplastics used as interleaving materials. Accordingly, method 100 includes a method of reducing pollution to the environment and/or reducing turbidity in water.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

1. A method of removing an interleaving material from glass to reduce enduring environmental pollution, the method comprising:
washing glass with a liquid including water by contacting the liquid with an interleaving material to remove the interleaving material from the glass, wherein the interleaving material includes substantially spherical microparticles including Lyocell, cellulose acetate, and disodium citrate, and is marine biodegradable, the interleaving material sinks in water and has a specific gravity of at least 1.03, and the interleaving material is sufficient to maintain a pH value of the liquid contacted with the interleaving material from about pH 6.5 to about pH 7.5.

2. (canceled)

3. The method of claim 1, wherein the interleaving material sinks in water and has a specific gravity of at least 1.1.

4. The method of claim 1, wherein the interleaving material further includes one or more of Rayon and microcrystalline cellulose (MCC).

5. (canceled)

6. (canceled)

7. (canceled)

8. The method of claim 1 further comprising capturing interleaving material prior to transferring the water to a downstream wastewater discharge process.

9. The method of claim 8, wherein capturing the interleaving material includes contacting the water and the interleaving material with a filter.

10. The method of claim 1, wherein the interleaving material is adhered to a surface of the glass prior to washing.

11. The method of claim 1, wherein the glass includes a plurality of glass sheets arranged into stacks.

12. An interleaving material, the interleaving material comprising: regenerated cellulose, wherein the interleaving material is marine biodegradable and has a specific gravity of at least 1.03.

13. The interleaving material of claim 12, wherein the regenerated cellulose includes one or more of Rayon, Lyocell, and microcrystalline cellulose (MCC).

14. The interleaving material of claim 12 further including disodium citrate, wherein the disodium citrate is in contact with the regenerated cellulose.

15. The interleaving material of claim 12 further including one or more carboxylic acids.

16. The interleaving material of claim 15, wherein the interleaving material is a monolithic interleaving powder.

17. The interleaving material of claim 12, wherein the regenerated cellulose is impinged with one or more of adipic acid, boric acid, sodium borate, citric acid, buffered citric acid, succinic acid, and tartaric acid.

18. The interleaving material of claim 12, wherein the interleaving material is in the form of a microparticle powder.

19. An interleaving material, the interleaving material comprising: regenerated cellulose and disodium citrate, wherein the interleaving material has a specific gravity of at least 1.03.

20. The interleaving material of claim 19, wherein the regenerated cellulose includes one or more of Rayon, Lyocell, and microcrystalline cellulose (MCC), and wherein the interleaving material is in the form of a microparticle powder.
